(19) United States
(12) Patent Application Publication
(10) Pub. No.: US 2026/0225809 A1
(43) Pub. Date: Aug. 6, 2026

(54) SYSTEMS AND METHODS INVOLVING A CONTAINER TRANSFER STATION BETWEEN A STORAGE STRUCTURE AND WORKSTATION OPERATOR

(71) Applicant: Symbotic LLC, Wilmington, MA (US)

(72) Inventors: Brian M. Gelblat, Cambridge, MA (US); Scott Hopkinson, Concord, MA (US); Devin W. Rochelle, West Boylston, MA (US)

(21) Appl. No.: 19/042,343

(22) Filed: Jan. 31, 2025

(51) Int. Cl. B65G 1/137; B65G 13/06

(52) U.S. Cl. CPC B65G 1/1378; B65G 13/065

(57) ABSTRACT

In some embodiments, apparatuses and methods are provided herein useful to the transfer of containers. In some embodiments, a system may include a storage structure including a plurality of pathways for movement of a plurality of mobile robots carrying containers, an operator handling area including an operator workstation at which items are transferred to and/or from containers by an operator, and a container transfer station intermediate the storage structure and the operator handling area, the container transfer station comprising: a mobile robot access side allowing deposit of containers from mobile robots in the storage structure, an operator handling area side receiving deposited containers, at least one rail supporting the deposited containers at the container transfer station; and a container transferer including a motor and cooperating with the at least one rail to move the deposited containers from the mobile robot access side to the operator handling area.

### TECHNICAL FIELD

This disclosure relates generally to automated storage and retrieval systems, and more particularly to the transfer of containers within such systems.

### BACKGROUND

Order fulfillment facilities may include automated storage and retrieval systems. Aspects of these automated storage and retrieval systems transfer containers between storage structures and operator handling areas within the facilities. There is a need to improve the transfer of containers within these systems. It is also desirable to provide a container transfer station separating mobile robots that may be traveling within the storage structure from operators at workstations.

### BRIEF DESCRIPTION OF DRAWINGS

Disclosed herein are embodiments of systems, apparatuses and methods pertaining to systems and methods for the transfer of containers within an automated storage and retrieval system. This description includes drawings, wherein:

FIG. 1 is a perspective view of an order fulfillment facility in accordance with some embodiments;

FIG. 2 is a perspective view of an order fulfillment facility in accordance with several embodiments;

FIG. 3 is a perspective view of an order fulfillment facility in accordance with some embodiments;

FIG. 4 is a side view of a transfer system in accordance with some embodiments;

FIG. 5 is a schematic diagram of a transfer system in accordance with several embodiments;

FIG. 6 is a schematic diagram of a transfer system in accordance with some embodiments;

FIG. 7 is a perspective view of a container transferer in accordance with several embodiments;

FIG. 8 is a top view of a container transferer in accordance with some embodiments;

FIG. 9 is a perspective view of a container transferer in accordance with several embodiments;

FIG. 10 is a side view of a container transferer in accordance with some embodiments;

FIG. 11 is a side view of a container transferer in accordance with several embodiments;

FIG. 12 is a side view of a container transferer with a container in accordance with some embodiments;

FIG. 13 is a top view of a transfer system in accordance with several embodiments;

FIG. 14 is a top view of a transfer system in accordance with some embodiments; and

FIG. 15 is a flow diagram of a method for transferring containers in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein useful to the transfer of containers. In some embodiments, an automated order fulfillment system includes: a storage structure including a plurality of pathways allowing movement of a plurality of mobile robots carrying containers therealong; an operator handling area including an operator workstation at which items are transferred to and/or from containers by an operator; a container transfer station intermediate the storage structure and the operator handling area, the container transfer station including: a mobile robot access side allowing deposit of containers from mobile robots in the storage structure to the container transfer station; an operator handling area side receiving deposited containers from the container transfer station; at least one rail supporting the deposited containers at the container transfer station; and a container transferer comprising a motor and cooperating with the at least one rail to move the deposited containers from the mobile robot access side to the operator handling area.

In some implementations, the container transferer includes at least one roller, the at least one roller being disengaged from a container occupying the container transfer station in a first position and the at least one roller being engaged to move the container occupying the container transfer station in a second position. In some implementations, the at least one roller includes at least one lobed roller, the at least one lobed roller including a flat portion being disengaged from the container in the first position and including a cylindrical portion for engagement with the container in the second position. In some implementations, the container transferer is movable from a first position that does not engage a container deposited on the at least one rail to a second position that engages the container deposited on the at least one rail. In some implementations, the system further includes at least one conveyor in the operator handling area, the at least one conveyor receiving the deposited containers from the container transferer and moving the deposited containers to at least one position accessible to the operator at the operator workstation. In some implementations, the at least one conveyor includes a plurality of conveyors, the plurality of conveyors moving the deposited containers to two or more positions at different vertical levels at the operator workstation. In some implementations, the operator handling area further comprises a channel to move a container to a different vertical level than a vertical level of the container transfer station. In some implementations, the system further includes a sensor at the mobile robot access side of the container transfer station to detect deposit of a container at the container transfer station. In some implementations, the container transfer station further includes a stop to limit movement of a container being deposited at the container transfer station past an end of the container transfer station. In some implementations, the storage structure, container transfer station, and operator handling area are configured such that the container transfer station creates a buffer area between mobile robots in the storage structure and the operator in the operator handling area.

In another form, there is provided a method for transferring containers, the method including: by a plurality of mobile robots, carrying containers at a storage structure including a plurality of pathways configured for movement of the plurality of mobile robots; and at a container transfer station intermediate the storage structure and an operator handling area, the operator handling area including an operator workstation at which items are transferred to and/or from containers by an operator; allowing, at a mobile robot access side, deposit of containers from mobile robots in the storage structure to the container transfer station; receiving, at an operator handling area side, deposited containers from the container transfer station; supporting, by at least one rail, the deposited containers at the container transfer station; and cooperating, by a container transferer, with the at least one rail to move the deposited containers from the mobile robot access side to the operator handling area.

In some implementations, the container transferer includes at least one roller, the at least one roller being disengaged from a container occupying the container transfer station in a first position and the at least one roller being engaged to move the container occupying the container transfer station in a second position. In some implementations, the at least one roller includes at least one lobed roller, the at least one lobed roller including a flat portion being disengaged from the container in the first position and including a cylindrical portion for engagement with the container in the second position. In some implementations, the method further includes, by the container transferer, moving from a first position that does not engage a container deposited on the at least one rail to a second position that engages the container deposited on the at least one rail. In some implementations, the method further includes, receiving, by at least one conveyor in the operator handling area, the deposited containers from the container transferer and moving the deposited containers to at least one position accessible to the operator at the operator workstation. In some implementations, the at least one conveyor includes a plurality of conveyors, the method further including: moving, by plurality of conveyors, the deposited containers to two or more positions at different vertical levels at the operator workstation. In some implementations, the method further includes, at a channel in the operator handling area, moving a container to a different vertical level than a vertical level of the container transfer station. In some implementations, the method further includes, by a sensor at the mobile robot access side of the container transfer station, detecting deposit of a container at the container transfer station. In some implementations, the method further includes, by a stop at the container transfer station, limiting movement of a container being deposited at the container transfer station past an end of the container transfer station. In some implementations, the method further includes configuring the storage structure, container transfer station, and operator handling area such that the container transfer station creates a buffer area between mobile robots in the storage structure and the operator in the operator handling area.

The following description is not to be taken in a limiting sense, but is made merely for the purpose of describing the general principles of example embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the disclosure. Thus, appearances of the phrases “in one embodiment,” “in an embodiment,” “in some embodiments”, “in some implementations”, and similar language throughout this specification may, but do not necessarily, all refer to the same embodiment.

In one aspect, and without limitation, this disclosure may involve generally a facility, such as an order fulfillment facility, which may include multiple mobile robots that operate to pick and transfer containers in the context of an automated storage and retrieval system (ASRS). In one form, mobile robots move about a storage structure and retrieve containers of goods (which may also be referred to as totes) that are stored in specific storage locations in the facility, as part of the ASRS. The facility may include operator handling stations, also referred to as tote processing stations or workstations, where containers, or totes, may be inducted into or dispensed from the ASRS by an operator. These containers may be transferred at storage structures to and from the mobile robots.

In one aspect, and without limitation, this disclosure may involve generally an order fulfillment facility and system that may involve the transfer of containers between storage structures and operator handling areas. In some forms, the facility may include a container transfer station for the transfer of containers between a storage structure and an operator handling area. It may be desirable to create a barrier, or a handoff/intermediary sub-system, between mobile robots in the storage structure and the operator handling area. Also, it may be desirable to increase container throughput to an operator workstation in the operator handling area.

In one aspect, and without limitation, this disclosure relates to a container transfer station intermediate a storage structure navigable by mobile robots carrying totes and an operator handling area. The container transfer station may receive containers from mobile robots at a mobile robot access side adjacent to the storage structure and may transfer containers to the operator handling area from an operator handling side. This configuration may reduce mobile robot travel interruptions and cycle time by providing additional deposit locations for containers during transfer to an operator handling area.

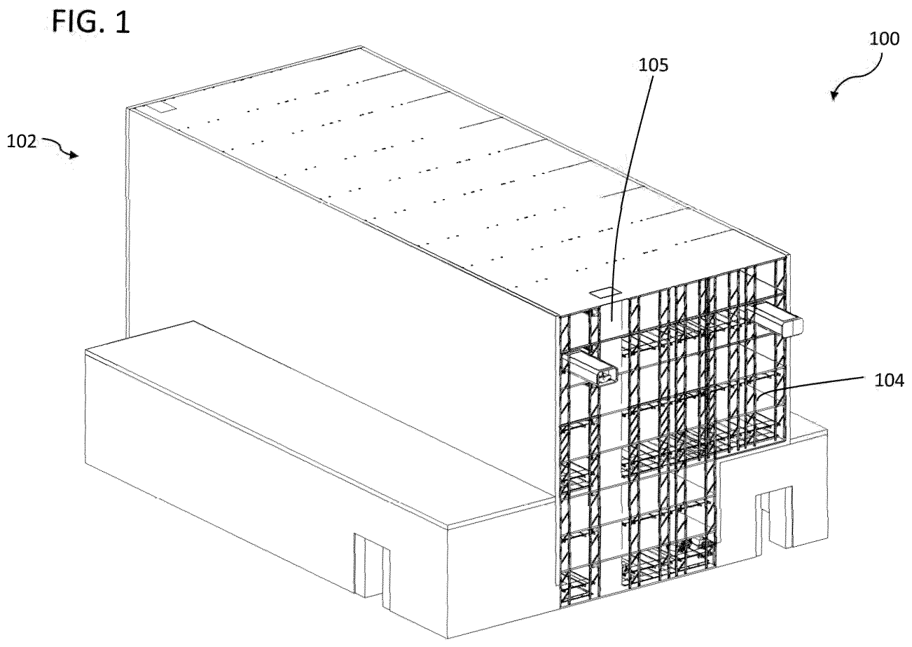

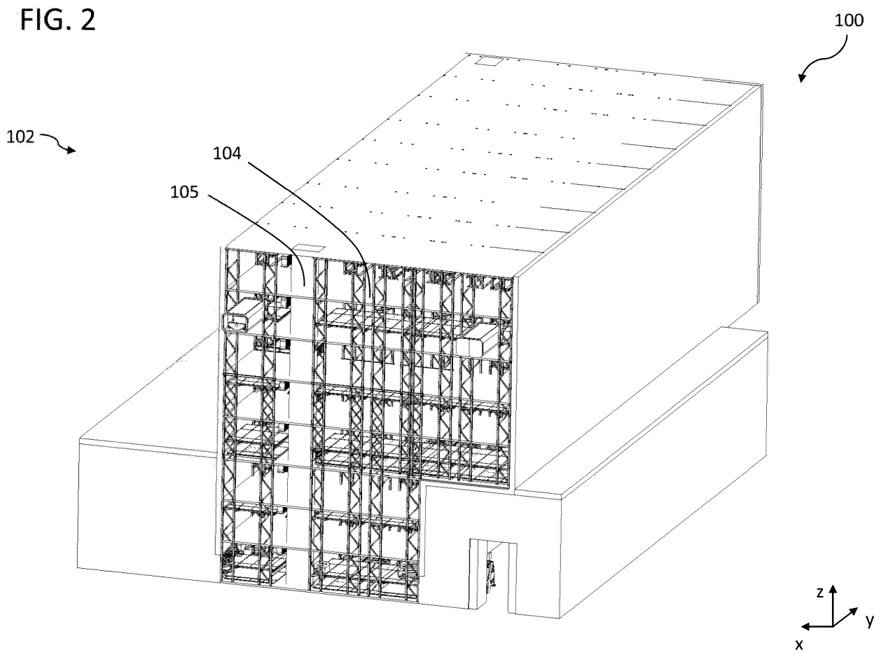

FIGS. 1-3 show parts of an order fulfillment facility 100 (or storage facility) that utilizes an ASRS in accordance with some embodiments. More specifically, as part of the ASRS, FIGS. 1 and 2 show a storage structure 102 that is generally intended to store various items at a number of storage locations 104. In one form, the storage structure 102 may include a y-z array of storage locations 104 in horizontal rows and climbing channels 105 (which also may be referred to as vertical towers or level changing towers) along the rows. In some forms, mobile robots may travel between storage levels in the z-direction within the climbing channels 105. Rows of storage locations 104 may be arranged to face each other, separated by horizontal pathways or aisles 106.

The storage structure 102 may further include decks 108 (which may also be referred to as transit planes or areas) spaced apart at different horizontal levels of the storage structure 102. The decks 108 may extend between the aisles 106 so that mobile robots can maneuver in the x-y plane of each deck 108 to travel between different aisles 106. Further details relating to the general structure and operation of embodiments of storage structures and mobile robots, such as may be used in conjunction with this disclosure, are disclosed in U.S. Pat. No. 9,139,363, issued Sep. 22, 2015, entitled “Automated System for Transporting Payloads”; U.S. Pat. No. 10,040,632, issued Aug. 7, 2018, entitled” Automated System for Transporting Payloads”; U.S. Pat. No. 10,435,241, issued Oct. 8, 2019, entitled “Storage and Retrieval System”; U.S. Pat. No. 10,952,533, issued Mar. 23, 2021, entitled “Modular Structure for an Automated Storage and Retrieval System”; and U.S. Pat. No. 11,142,398, issued Oct. 12, 2021, entitled “Order Fulfillment System”; which patents are all incorporated by reference herein in their entirety.

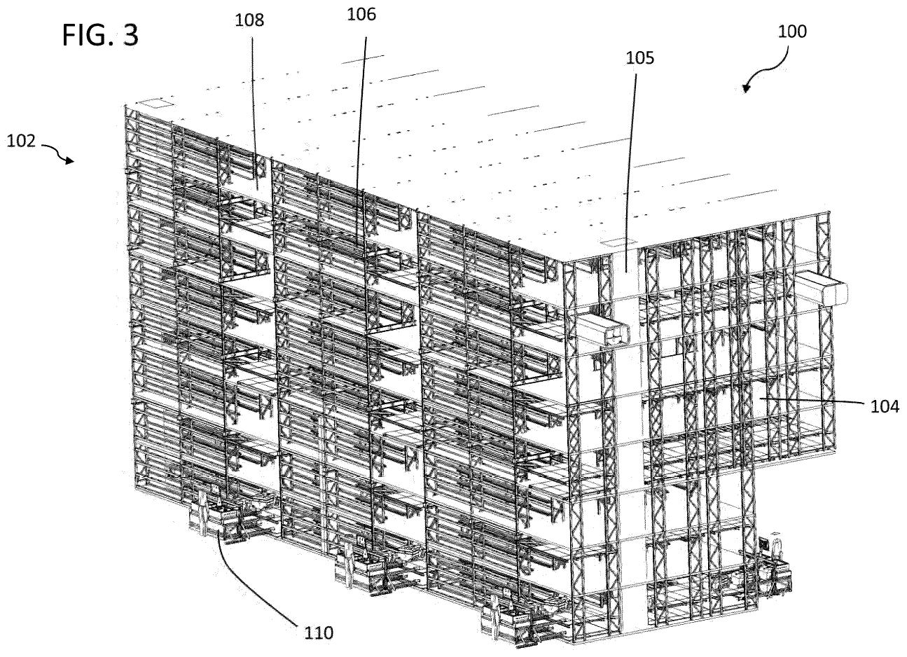

FIG. 3 shows container processing stations 110 at the order fulfillment facility 100 in accordance with some embodiments. In one form, operators (human individuals and/or robotic operators) work at the container processing stations 110. Various operations may be performed at the container processing stations 110. Mobile robots may perform transport operations, including moving containers between storage locations 104 and the container processing stations 110 and including transporting order containers away from the container processing stations. Examples of container processing stations 110 and picking and transfer operations, such as may be used in conjunction with this disclosure, are disclosed, for example, in U.S. Pat. No. 11,845,610, issued Dec. 19, 2023, entitled “Automated Decant System”; U.S. Patent Publication No. 2021/0380343, published Dec. 9, 2021, entitled “Robotic Each Picking in a Micro-Fulfillment Center”; and U.S. Pat. No. 10,984,375, issued Apr. 20, 2021, entitled “Picking Workstation with Mobile robots and Machine Vision Verification of Each Transfers Performed by Human Operators,” all of which are incorporated by reference herein in their entirety.

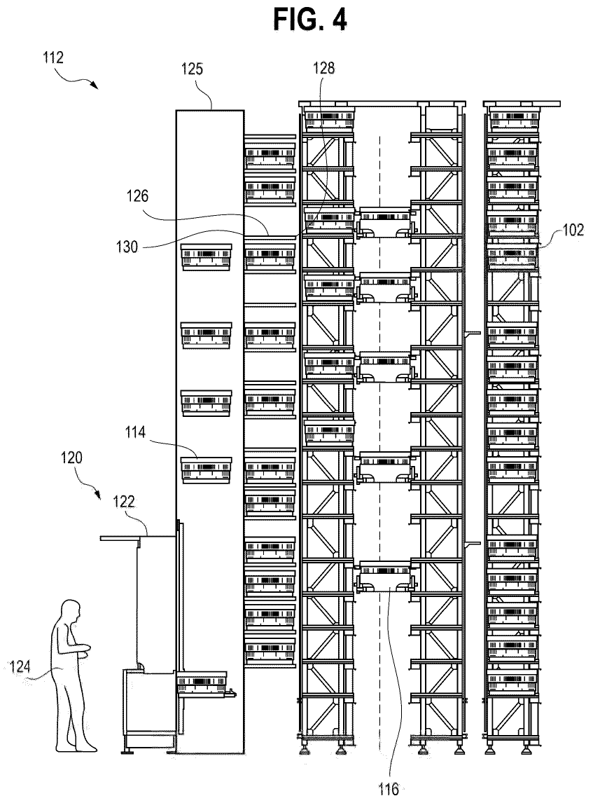

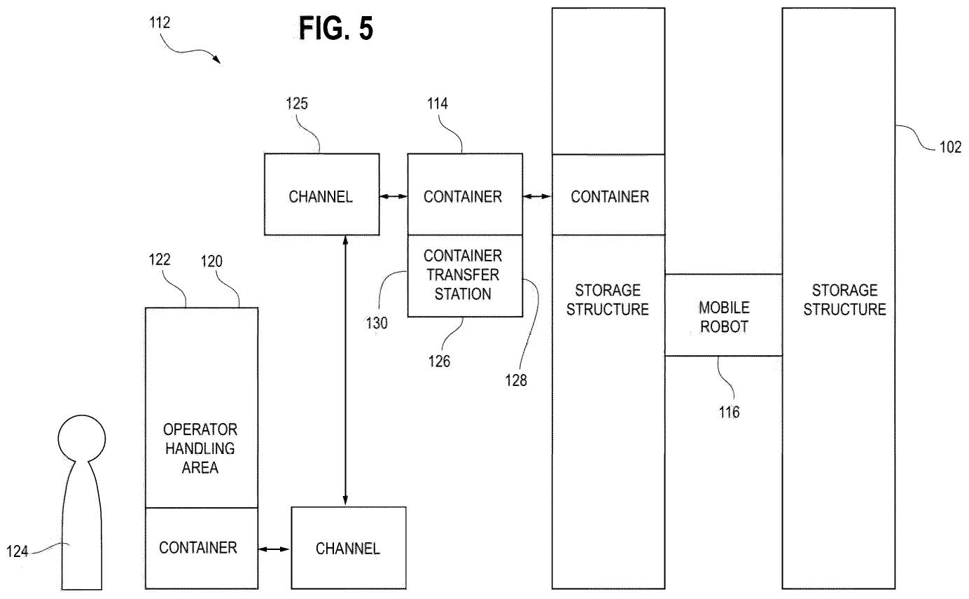

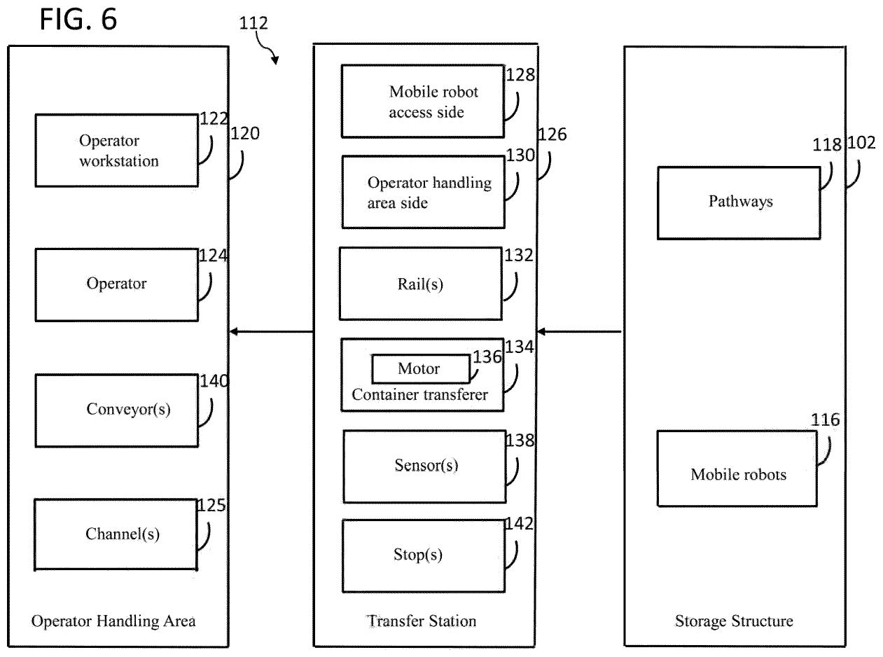

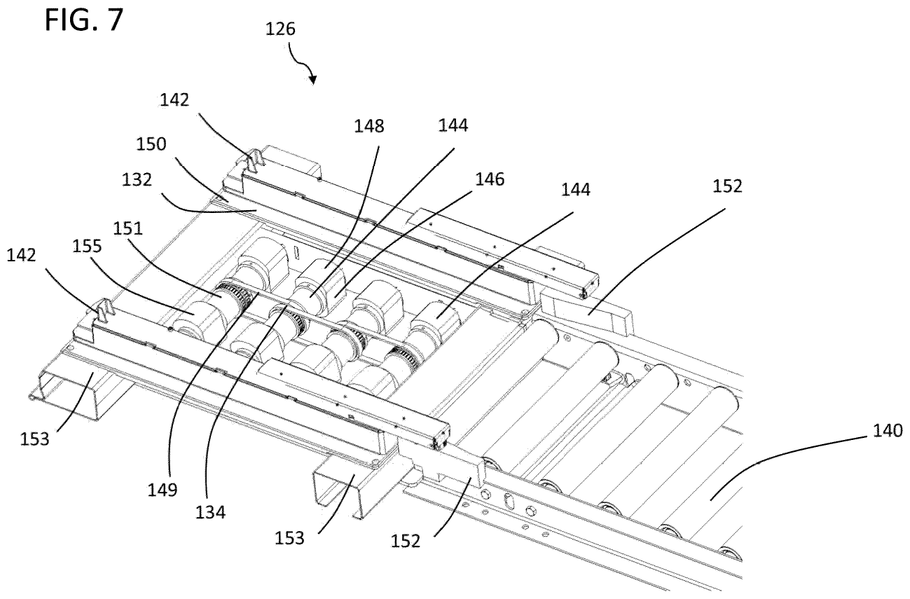

FIGS. 4-6 show a system 112 for the transfer of containers 114 in accordance with some embodiments. In some forms, the system 112 may be used as part of an overall ASRS. It is generally contemplated that the system 112 allows for containers 114 to be received and transferred within the order fulfillment facility 100. In one form, the system 112 facilitates the transfer of containers 114 at locations within the order fulfillment facility 100. The system 112 may include the storage structure 102 in accordance with some embodiments. The storage structure 102 may allow the movement of a plurality of mobile robots 116 carrying containers 114 therein. FIG. 7 shows the storage structure 102 including pathways 118 (e.g., the climbing channels 105 and the aisles 106) allowing the movement of the mobile robots 116 throughout the storage structure 102.

The system 112 may include an operator handling area 120 in accordance with some embodiments. The operator handling area 120 may include an operator workstation 122. At the operator workstation 122, items are generally transferred to and/or from containers 114 by an operator 124 (human individuals and/or robotic operators).

The system 112 may include a container transfer station 126 intermediate the storage structure 102 and the operator handling area 120 in accordance with some embodiments. In some forms, the storage structure 102, the container transfer station 126, and the operator handling area 120 are configured such that the container transfer station 126 creates a buffer area between mobile robots 116 in the storage structure 102 and the operator 124 in the operator handling area 120. In other words, the described configuration of the storage structure 102, the container transfer station 126, and the operator handling area 120 decreases exposure of an operator 124 to mechanical components of the system 112, consequently increasing safety. In some forms, the container transfer station 126 acts as a handoff/intermediary sub-system for container transfer between mobile robots and the operator working area. In some forms, it acts to decouple the automation system from the workstation.

The container transfer station 126 may include a mobile robot access side 128 in accordance with some embodiments. The mobile robot access side 128 may allow the deposit of containers 114 from the mobile robots 116 in the storage structure 102 to the container transfer station 126. In some forms, the mobile robot access side 128 is generally adjacent to the storage structure 102. In some forms, the container transfer station 126 receives containers 114 at the mobile robot access side 128 directly from the storage structure 102. In some embodiments, an intermediate structure (e.g., a conveyor, rollers, a storage location, etc.) may receive a container 114 from a mobile robot 116, and the container 114 may then be transferred from this intermediate structure to the container transfer station 126.

The container transfer station 126 may include an operator handling area side 130 in accordance with some embodiments. The operator handling area side 130 may receive deposited containers 114 from the container transfer station 126. In some forms, the operator handling area side 130 may be generally adjacent to the operator workstation 122. In some forms, the container transfer station 126 may receive containers 114 at the operator handling area side 130 directly from the container transfer station 126. In some embodiments, an intermediate structure (e.g., a conveyor, rollers, a storage location, a channel or shaft, etc.) may receive a container 114 from the container transfer station 126, and then, the container 114 may be transferred from the intermediate structure to the operator workstation 122.

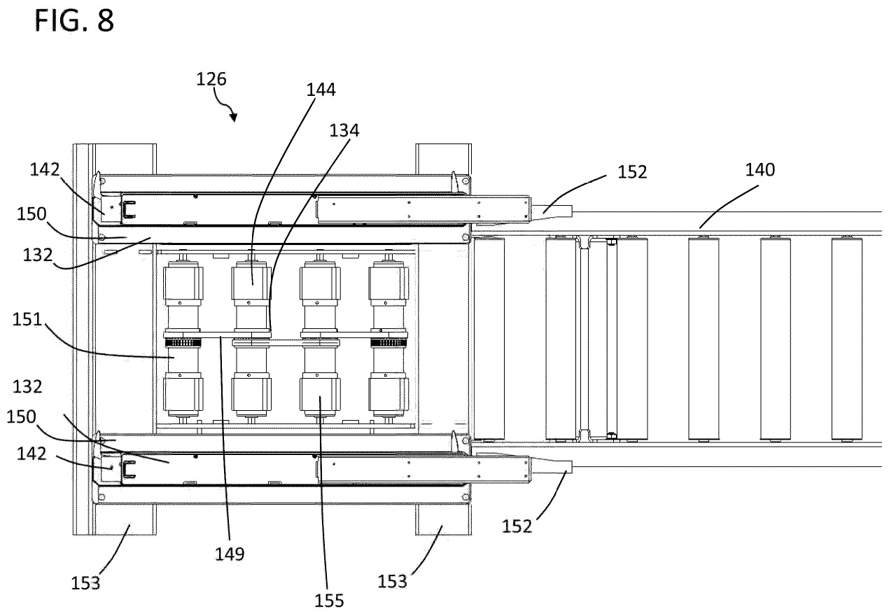

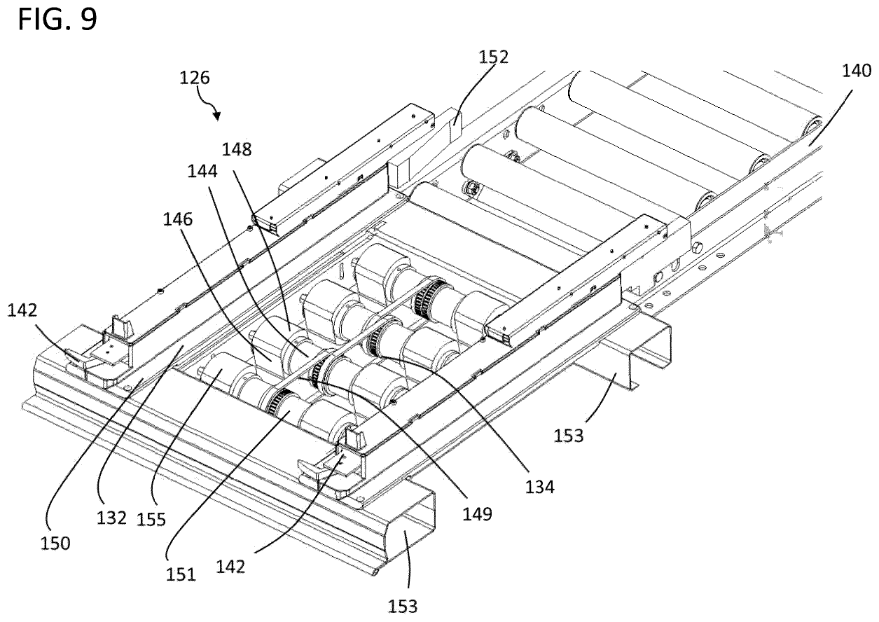

The container transfer station 126 may include at least one rail 132 in accordance with some embodiments. The rail 132 may support the deposited containers 114 at the container transfer station 126. In other words, an upper surface of a rail 132 may support a lower surface of a container 114. In some forms, rails 132 may be spaced apart and engage a first and second side of a container 114. In some forms, the rails 132 may further be used to guide a container 114 within the container transfer station 126. FIGS. 7-12 show examples of two rails 132 in accordance with some embodiments.

The container transfer station 126 may include a container transferer 134 in accordance with some embodiments. The container transferer 134 may include a motor 136 and cooperate with the rail 132 to move the deposited containers 114 from the mobile robot access side 128 to the operator handling area side 130. It is generally contemplated that the motor 136 may power the container transferer 134, such as, for example, energizing a conveyor or roller(s). In some forms, the container transferer 134 may fit between two rails 132 and/or beneath the two rails 132. In some embodiments the container transferer 134 and/or the container transfer station 126 are at least the width and the length of a container 114. An example of a container transfer station 126 and components thereof are further shown in FIGS. 7-12.

The system 112 may further include a sensor 138 at the mobile robot access side 128 of the container transfer station 126 in accordance with some embodiments. The sensor 138 may detect the deposit of a container 114 at the container transfer station 126. In some forms, the detection of a container 114 by the sensor 138 may cause actuation of a proximate mechanism (e.g., a conveyor, rollers, elevators, etc.) to further move a container 114. The sensor 138 may be in the form of proximity sensors, magnetic sensors, laser sensors, and so forth. It is generally contemplated that any additional sensors may be used to determine the presence of a container 114 at various locations at or near the container transfer station 126 (e.g., the operator handling area side 130, an elevator shaft or channel, and so forth), and detection of a container 114 may cause actuation of any suitable mechanisms/components of the system 112.

The system 212 may further include at least one conveyor 140 (separate from the container transferer 134) in the operator handling area 120 in accordance with some embodiments. The conveyor 140 may receive the deposited containers 114 from the container transferer 134 and transport them to at least one position accessible to the operator 124 at the operator workstation 122. In some forms, a plurality of conveyors 140 may move the deposited containers 114 to multiple positions at different vertical levels at the operator workstation 122. The conveyor(s) 140 may be in the form of a belt conveyor, a chain conveyor, roller conveyors, overhead conveyors, etc. In some forms, there may be additional conveyors 140 within the system 112, such as, for example, transferring containers 114 from mobile robots 116 to the container transfer station 126.

The operator handling area 120 may further include a channel 125 (such as, for example, a vertical shaft or conduit) in accordance with some embodiments. The channel 125 may allow a container 114 to be moved to a different vertical level than a vertical level of the container transfer station 126. In some forms, the channel 125 may accommodate a lift mechanism, an elevator, vertical transfer mechanism, etc. In some forms, the channel 125 may be controlled by local sensors, which may be used to validate the physical location of a container 114 within the channel 125. In some forms, the channel 125 may be controlled by a robotic control system of the order fulfillment facility 100. In some forms, the robotic control system controls movement and sequencing of the mobile robots 116 within the order fulfillment facility 100.

FIGS. 7-12 show the container transfer station 126 and a container transferer 134 in accordance with some embodiments. In some forms, the container transferer 134 may include rollers 144. The rollers 144 may be in the form of individually actuatable rollers, retractable rollers, lobed rollers, multi-directional rollers, and so forth. In some embodiments, the roller 144 may be in the form of a lobed roller, an eccentric roller, or a cam mechanism.

When in the form of a lobed roller, the lobed roller may have a generally oval shaped cross-section or obround cross-section. An obround cross-section is generally in the shape of a race track with two semicircles at the ends connected to each other by two parallel lines. The lobed roller may include two flat portions 146 connecting two half-cylinders, or two cylindrical portions 148, to each other. While FIGS. 7-12 show four rollers 144 in the form of lobed rollers, each with two flat portions 146 and two cylindrical portions 148, it is generally contemplated that, in some forms, the rollers 144 may have a different shape such that the rollers 144 engage and then disengage from a container when in operation.

In some forms, the rollers 144 may be coupled to one another, such as, for example, by chain couplings 149, although various other types of couplings are also possible. This coupling of the rollers 144 may allow a motorized roller among the rollers 144 to cause other non-powered rollers to rotate, although, in other forms, some or all of the rollers 144 may be motorized. In some forms, the rollers 144 may have a general dumbbell shape. As can be seen in FIGS. 7-9, they may have a center portion that is generally in the form of a cylindrical shaft 151 that extends to two larger cross-section end portions 155 at the ends of the cylindrical shaft 151 with each end portion 155 having an obround cross-section.

Generally, the rollers 144 are rotatable in at least the direction of travel of a container 114 along the container transferer 134. In some forms, the rollers 144 may be timed to rotate/move for a pre-determined length of time (e.g., 10 seconds, 15 seconds, and so forth). In some forms, the rollers 144 rotate for a pre-determined number of revolution (e.g., one revolution, two revolutions, three revolutions, and so forth). In some embodiments, such as when the rollers 144 are in the form of lobed rollers, the roller 144 may only perform a partial revolution, such as, for example, from a flat portion 146 to a cylindrical portion 148.

In some forms, the rollers 144 may rotate relative to a position of a container 114 on the container transferer 134. For example, in some embodiments, a sensor positioned proximate the mobile robot access side 128 may detect a container 114 deposited at the container transfer station 126. In response to the detection of a container 114, rollers 144 of the container transferer 134 may actuate until a sensor positioned proximate the operator handling area side 130 detects the container 114. In other words, the location of the container 114 on the container transferer 134 and/or the container transfer station 126 may assist in controlling actuation of the container transferer 134 and components thereof.

In some embodiments, the container transferer 134 is movable from a first position 154 that does not engage a container 114 deposited on the rails 132 to a second position 156 that engages a container 114 on the rails 132. In some forms, a container 114 may be moved across the container transfer station 126 when the container transferer 134 engages it in the second position 156. While FIGS. 7-12 show the container transferer 134 including rollers 144, it is generally contemplated that the container transferer 134 may include any alternate and/or additional mechanisms moveable between a first, disengaged position 154 and a second, engaged position 156 (e.g., a retractable conveyor).

In some embodiments, the container transfer station 126 may further include a sliding surface 150. In some forms, the sliding surface 150 is an upper surface of the rails 132 to facilitate movement of a container 114 from one end to the other end of the container transfer station 126. In some forms, the sliding surface 150 may have a lesser coefficient of friction than other components of the container transfer station 126 (e.g., rollers 144). The comparatively lesser coefficient of friction may allow a container 114 to be more easily moved through the container transfer station 126.

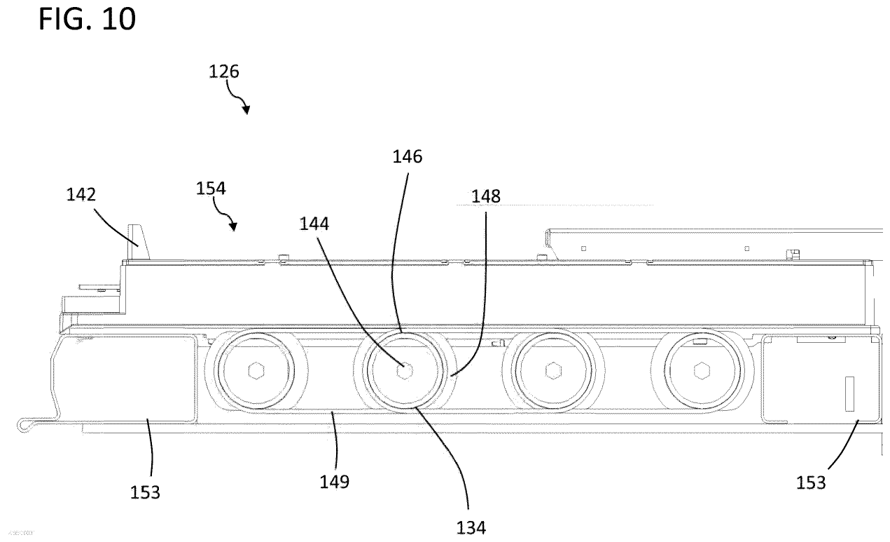

FIG. 10 shows rollers 144 in a first position 154 in accordance with some embodiments. A container 114 occupying the container transfer station 126 may be disengaged from the rollers 144 in the first position 154. In embodiments where the rollers 144 are in the form of lobed rollers, the flat portion 146 of each roller 144 may be disengaged from the container 114 in the first position 154. In other words, in the first position 154, the container 114 may be engaged with the rail(s) 132 and not with the rollers 144. In this first position, the rollers 144 are retracted/nested beneath the rails 132 (i.e., because the flat portion 146 is at the top of each lobed roller 144 in this first position). Lobed rollers 144 may be in this disengaged position when a mobile robot 116 initially deposits and transfers the container 114 to the station 126. In some forms, it is contemplated that there might be some slight engagement between the rollers 144 and container 114 in this first position.

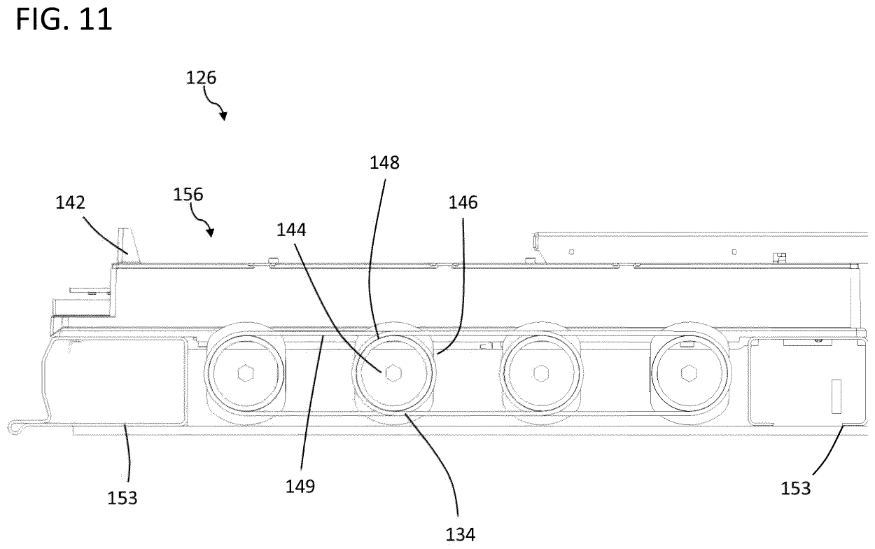

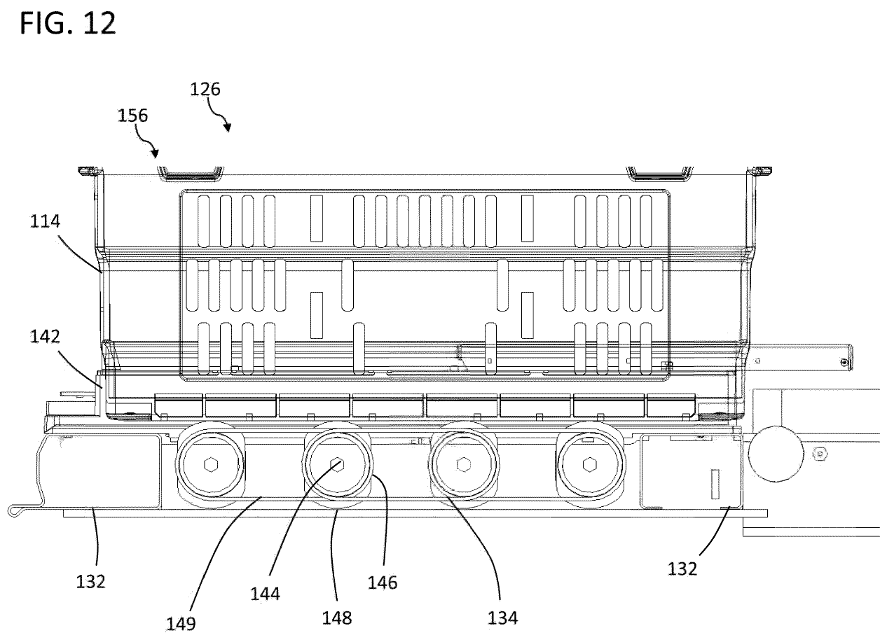

FIGS. 11 and 12 show the rollers 144 in a second position 156. A container 114 occupying the container transfer station 126 may be engaged with and may be moved by the rollers 144 in the second position 156. In embodiments where the rollers 144 are in the form of lobed rollers, the cylindrical portions 148 of each roller 144 may engage with the container 114 in the second position 156. In other words, in the second position 156, the container 114 may be engaged with the rollers 144 and not the rail(s) 132. In this second position, the rollers 144 extend above the rails 132 and are in a raised position (i.e., because the cylindrical portion 148 is now positioned at the top of each lobed roller 144 in this second position). In some forms, the container 114 may sit at the container transfer station 126 until timed or periodic operation moves it off the station 126 and onward to the operator workstation 122.

The container transfer station 126 may further include a stop 142 in accordance with some embodiments. The stop 142 may limit movement of a container 114 being deposited at the container transfer station 126 past an end of the container transfer station 126. In other words, the stop 142 prevents a container 114 from moving off of the container transferer 134 and/or container transfer station 126. In some forms, the stop 142 may temporarily limit movement of the container 114 being deposited, until an indication is received that the container 114 may continue transfer (e.g., that an adjacent mechanism is ready to receive the container 114). The stop 142 may be in the form of moveable flippers, static stops, and so forth.

In some embodiments, as shown in FIGS. 7-9, the container transfer station 126 may further include a guide funnel 152. The guide funnel 152 may aid in guiding a container 114 onto and/or off of the container transfer station 126. In some forms, the guide funnel 152 defines a width dimension of the container transfer station 126. In some embodiments, the guide funnel 152 may guide a container 114 to and/or from an ancillary mechanism, such as a conveyor 140 and/or a channel 125.

In some embodiments, as shown in FIGS. 7-12, the container transfer station 126 further includes system support rails 153. These rails 153 may be a second set of rails in addition to the first set of rails 132 that directly support the containers 114. The system support rails 153 may couple to structures within and support the order fulfillment facility 100 (e.g., the storage structure 102). In some forms, these system support rails 153 may represent a boundary of the storage structure 102, and positioning the container transfer station 126 at this location adapts the station 126 for use with existing storage and boundary structures in the system. While two system support rails 153 are shown, it is generally contemplated that any suitable number of system support rails 153 may be used to structurally support the system 112 and components thereof.

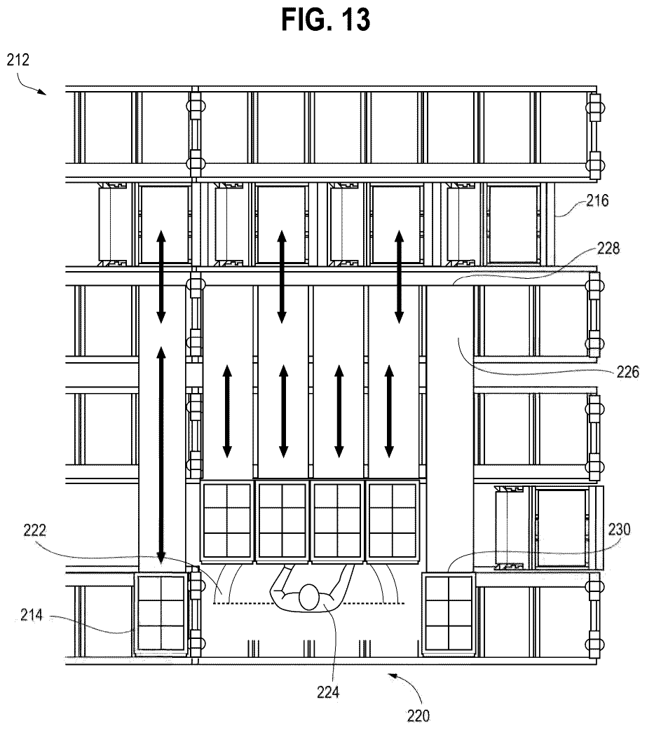

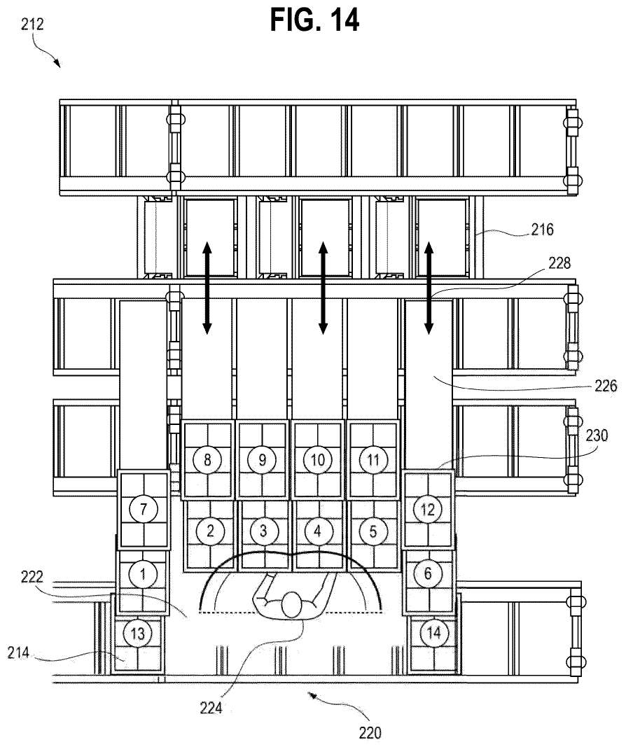

FIGS. 13 and 14 show a system 212 for the transfer of containers in accordance with some embodiments. It is generally understood that components of the system 212 may be the same or similar as components of the system 112 and are represented in the 200 series. For example, the containers 114 of the system 112 described herein are generally considered to be the same as containers 214 of the system 212. In some forms, the system 212 may be used as part of an overall ASRS. It is generally contemplated that the system 212 allows for containers 214 to be received and transferred within the order fulfillment facility 100. In one form, the system 212 facilitates the transfer of containers 214 at locations within the order fulfillment facility 100. The system 212 may include the storage structure 102 in accordance with some embodiments.

As shown in FIGS. 13 and 14, mobile robots 216 deposit containers 214 at a mobile robot access side 228 of the container transfer station 226. Deposited containers 214 are transported across the container transfer station 226 and are received at an operator handling area side 230 of the container transfer station 226 adjacent an operator handling area 220. In this embodiment, the container transfer station 226 may be in the form of a conveyor that connects a mobile robot drop-off location to an operator workstation 222. Conversely, in some forms, containers 214 can be deposited at the operator handling area side 230 of the container transfer station 226 from the operator workstation 222 and transferred for receipt by mobile robots 216 at the mobile robot access side 228 of the container transfer station 226. As shown, the operator handling area 220 includes an operator workstation 222 operated by an operator 224.

FIGS. 13 and 14 show multiple horizontally spaced container transfer stations 226. It is also contemplated that the container transfer stations 226 may be multi-level container transfer stations 226 in accordance with some embodiments. In some embodiments, the operator workstation 222 may be able to receive a number of different containers at different levels about the operator workstation 222. In one example, as shown in FIG. 14, there may be fourteen locations that may receive containers 214 about the operator workstation 222, although a different number of locations is possible. In this example in FIG. 14, it is contemplated that there may be two containers 214 at a first level, six containers 214 at a second level, and six containers 214 at a third level, totaling fourteen containers 214. It is generally understood that there may be any alternate number and/or configuration of the container transfer stations 226 and/or levels of the container transfer stations 226.

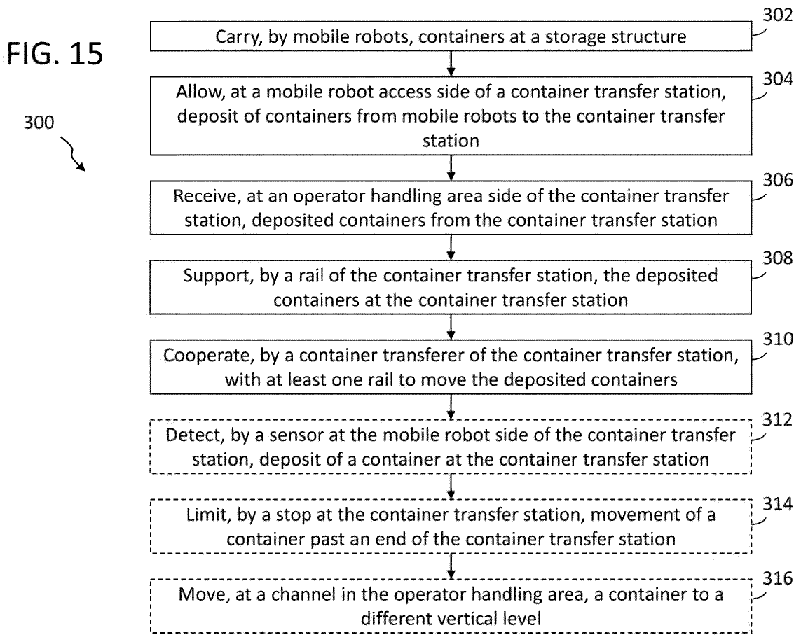

FIG. 15 shows a process 300 for the transfer of containers in accordance with some embodiments. In one form, it is contemplated that the transfer of containers between a storage structure and an operator handling area may involve an ASRS at an order fulfillment facility. The process 300 may use some or all of the components described above, such as, for example, components of the systems for the transfer of containers described above.

In some forms, one or more blocks of the process may be performed at about the same time or in a different order than illustrated in the figures. In some forms, the process may not include all of the blocks/steps shown, may include additional blocks/steps, and/or some blocks/steps may be combined. In some forms, some of the blocks/steps may be repeated.

At block 302, containers at a storage structure are transported by a plurality of mobile robots. It is generally contemplated that the storage structure includes a plurality of pathways configured for movement of the mobile robots.

At block 304, a container transfer station intermediate the storage structure and an operator handling area allows, at a mobile robot access side of the container transfer station, deposit of containers from mobile robots in the storage structure to the container transfer station. It is generally contemplated that the operator handling area includes an operator workstation at which items are transferred to and/or from containers by an operator. In some forms, the configuration of the storage structure, the container transfer station, and the operator handling area creates a buffer between mobile robots in the storage structure and the operator in the operator handling area. In some embodiments, the operator handling area includes at least one conveyor that receives deposited containers from the container transferer and moves the deposited containers to at least one position accessible to the operator at the operator workstation. In further forms, multiple conveyors may move deposited containers to corresponding positions at different vertical levels at the operator workstation.

At block 306, the container transfer station receives, at an operator handling area side of the container transfer station, deposited containers from the container transfer station. At block 308, the container transfer station supports, by at least one rail of the container transfer station, the deposited containers at the container transfer station.

At block 310, the container transfer station cooperates, by a container transferer of the container transfer station, with the at least one rail to move the deposited containers from the mobile robot access side to the operator handling area. In some forms, the container transferer is movable from a first position that does not engage a container deposited on the rail to a second position that engages the container deposited on the rail. In some embodiments, the container transferer includes at least one roller disengageable from a container occupying the container transfer station in a first position and engageable to move the container occupying the container transfer station in a second position. In some forms, the roller may be a lobed roller including a flat portion being disengaged from the container in the first position and cylindrical portion for engagement with the container in the second position.

Optionally, at block 312, deposit of a container at the container transfer station is detected by a sensor at the mobile robot access side of the container transfer station. Optionally, at block 314, a stop at the container transfer station limits movement of a container being deposited at the container transfer station past an end of the container transfer station. Optionally, at block 316, a channel in the operator handling area moves a container to a different vertical level than a vertical level of the container transfer station.

Those skilled in the art will recognize that a wide variety of other modifications, alterations, and combinations can also be made with respect to the above described embodiments without departing from the scope of the disclosure, and that such modifications, alterations, and combinations are to be viewed as being within the ambit of the inventive concept.

1. An automated order fulfillment system comprising:
a storage structure including a plurality of pathways allowing movement of a plurality of mobile robots carrying containers therealong;
an operator handling area including an operator workstation at which items are transferred to and/or from containers by an operator; and
a container transfer station intermediate the storage structure and the operator handling area, the container transfer station comprising:
a mobile robot access side allowing deposit of containers from mobile robots in the storage structure to the container transfer station;
an operator handling area side receiving deposited containers from the container transfer station;
at least one rail supporting the deposited containers at the container transfer station; and
a container transferer comprising a motor and cooperating with the at least one rail to move the deposited containers from the mobile robot access side to the operator handling area.

2. The system of claim 1, wherein the container transferer comprises at least one roller, the at least one roller being disengaged from a container occupying the container transfer station in a first position and the at least one roller being engaged to move the container occupying the container transfer station in a second position.

3. The system of claim 2, wherein the at least one roller comprises at least one lobed roller, the at least one lobed roller including a flat portion being disengaged from the container in the first position and including a cylindrical portion for engagement with the container in the second position.

4. The system of claim 1, wherein the container transferer is movable from a first position that does not engage a container deposited on the at least one rail to a second position that engages the container deposited on the at least one rail.

5. The system of claim 1, further comprising at least one conveyor in the operator handling area, the at least one conveyor receiving the deposited containers from the container transferer and moving the deposited containers to at least one position accessible to the operator at the operator workstation.

6. The system of claim 5, wherein the at least one conveyor comprises a plurality of conveyors, the plurality of conveyors moving the deposited containers to two or more positions at different vertical levels at the operator workstation.

7. The system of claim 1, wherein the operator handling area further comprises a channel to move a container to a different vertical level than a vertical level of the container transfer station.

8. The system of claim 1, further comprising a sensor at the mobile robot access side of the container transfer station to detect deposit of a container at the container transfer station.

9. The system of claim 1, wherein the container transfer station further comprises a stop to limit movement of a container being deposited at the container transfer station past an end of the container transfer station.

10. The system of claim 1, wherein the storage structure, container transfer station, and operator handling area are configured such that the container transfer station creates a buffer area between mobile robots in the storage structure and the operator in the operator handling area.

11. A method for transferring containers comprising:
by a plurality of mobile robots, carrying containers at a storage structure including a plurality of pathways configured for movement of the plurality of mobile robots; and
at a container transfer station intermediate the storage structure and an operator handling area, the operator handling area including an operator workstation at which items are transferred to and/or from containers by an operator;
allowing, at a mobile robot access side, deposit of containers from mobile robots in the storage structure to the container transfer station;
receiving, at an operator handling area side, deposited containers from the container transfer station;
supporting, by at least one rail, the deposited containers at the container transfer station; and
cooperating, by a container transferer, with the at least one rail to move the deposited containers from the mobile robot access side to the operator handling area.

12. The method of claim 11, wherein the container transferer comprises at least one roller, the at least one roller being disengaged from a container occupying the container transfer station in a first position and the at least one roller being engaged to move the container occupying the container transfer station in a second position.

13. The method of claim 12, wherein the at least one roller comprises at least one lobed roller, the at least one lobed roller including a flat portion being disengaged from the container in the first position and including a cylindrical portion for engagement with the container in the second position.

14. The method of claim 11, further comprising, by the container transferer, moving from a first position that does not engage a container deposited on the at least one rail to a second position that engages the container deposited on the at least one rail.

15. The method of claim 11, further comprising receiving, by at least one conveyor in the operator handling area, the deposited containers from the container transferer and moving the deposited containers to at least one position accessible to the operator at the operator workstation.

16. The method of claim 15, wherein the at least one conveyor comprises a plurality of conveyors, the method further comprising:
moving, by plurality of conveyors, the deposited containers to two or more positions at different vertical levels at the operator workstation.

17. The method of claim 11, further comprising, at a channel in the operator handling area, moving a container to a different vertical level than a vertical level of the container transfer station.

18. The method of claim 11, further comprising, by a sensor at the mobile robot access side of the container transfer station, detecting deposit of a container at the container transfer station.

19. The method of claim 11, further comprising, by a stop at the container transfer station, limiting movement of a container being deposited at the container transfer station past an end of the container transfer station.

20. The method of claim 11, further comprising configuring the storage structure, container transfer station, and operator handling area such that the container transfer station creates a buffer area between mobile robots in the storage structure and the operator in the operator handling area.
